(19) United States
(12) Patent Application Publication
(10) Pub. No.: US 2013/0033878 A1
(43) Pub. Date: Feb. 7, 2013

(54) HEAT DISSIPATION MODULE AND LED ILLUMINATION DEVICE USING THE SAME

(71) Applicants: BEN-FAN XIA, KunShan City (CN); CHING-BAI HWANG, Tu-Cheng (TW); JUI-WEN HUNG, Tu-Cheng (TW)

(72) Inventors: BEN-FAN XIA, KunShan City (CN); CHING-BAI HWANG, Tu-Cheng (TW); JUI-WEN HUNG, Tu-Cheng (TW)

(73) Assignees: FOXCONN TECHNOLOGY CO., LTD., Tu-Cheng (TW); FURUI PRECISE COMPONENT (KUNSHAN) CO., LTD., KunShan City (CN)

(21) Appl. No.: 13/216,270

(22) Filed: Aug. 24, 2011

(30) Foreign Application Priority Data
Aug. 1, 2011 (CN) 201110217959.7

(51) Int. Cl. F21V 29/00

(52) U.S. Cl. 362/373

(57) ABSTRACT

A heat dissipation module includes a plurality of fins. Each fin includes a main body, a bottom bending plate bending from a bottom edge of the main body, a top bending plate bending from a top edge of the main body, and a slick flange folding inwards from an outer edge of the main body. The flange overlaps the main body at the outer edge of a corresponding fin. The present disclosure also relates to an LED illumination device using the heat dissipation module.

### BACKGROUND

1. Technical Field

The present disclosure relates generally to illumination devices, and more particularly to an LED illumination device having a heat sink.

2. Description of Related Art

LEDs as a source of LED illumination devices provide advantages such as resistance to shock and nearly limitless lifetime under specific conditions.

However, a lot of heat is generated during the work of the LEDs , which, if not adequately addressed, impacts the reliability of the LED illumination device. A typical way of providing an LED illumination device with good heat dissipation capability is increasing the pluralitys of fins in the LED illumination device. However, the increase of the fins requires the fins to be extremely thin. The extremely thin fins are easy to deform or even break, which not only impairs the heat dissipation capability of the light fixture, but also destroys the aesthetics of the light fixture. In addition, the extremely thin fins are so sharp that they are dangerous to the users during the installation or replacement of the LED illumination device.

What is needed therefore is an LED illumination device which can overcome the above limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is an assembled view of an LED illumination device in accordance with an embodiment of the present disclosure.

FIG. 2 is an isometric, exploded view of the LED illumination device of FIG. 1.

FIG. 3 is similar to FIG. 2, but viewed from a different aspect.

FIG. 4 is an enlarged view of a fin of the LED illumination device of FIG. 1.

### DETAILED DESCRIPTION

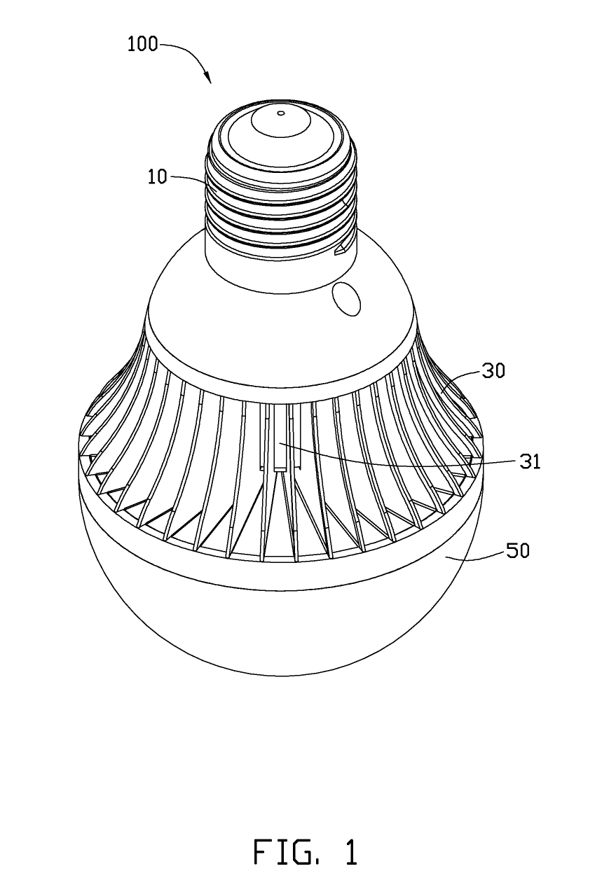

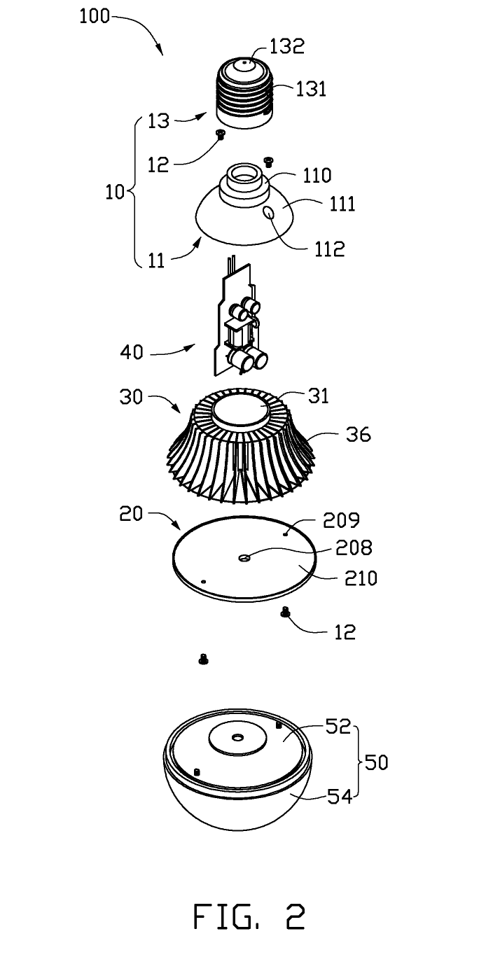

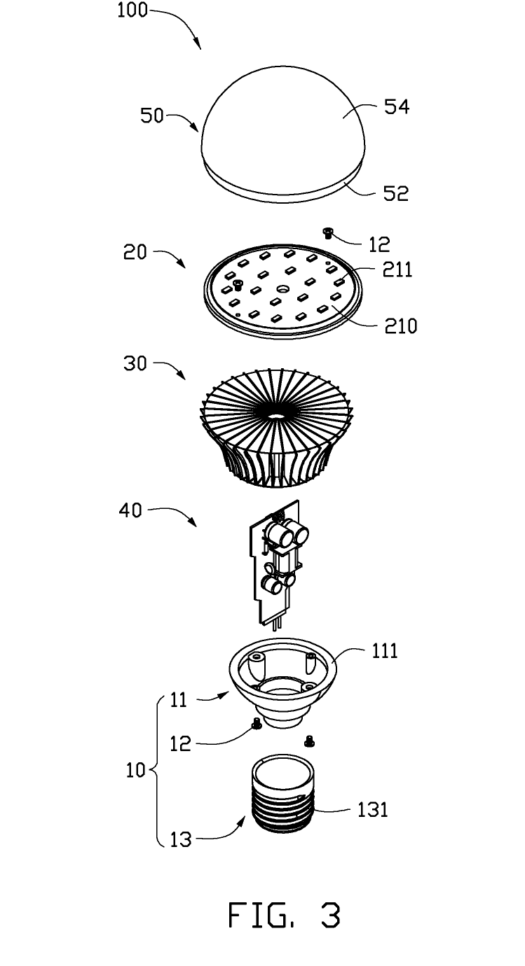

Referring to FIGS. 1, 2 and 3, an LED illumination device 100 in accordance with an embodiment of the present disclosure comprises a holder 10 for connecting with a power source (not shown), a power module 40, a heat dissipation module 30, an LED module 20 with a top end connecting with the heat dissipation module 30 and a bottom end connecting with an envelope 50.

The holder 10 comprises a conducting portion 13 and a connecting portion 11 extending downwardly from the conducting portion 13. The conducting portion 13 has a columned shape. Threads 131 are formed on an outer surface of the conducting portion 13. A conducting pad 132 is formed on a top end of the conducting portion 13. The conducting portion 13 is configured for connecting the power source to provide a power for the LED illumination device 100. The connecting portion 11 comprises a connecting bar 110 and a connecting bowl 111 extending downwardly from the connecting bar 110. The connecting bar 110 inserts into a bottom of the conducting portion 13 and engages the conducting portion 13. The connecting bowl 111 has a substantially spherical contour. Two positioning holes 112 are defined in the connecting bowl 111 for screws 12 extending therethrough to connect the holder 10 and the heat dissipation module 30 together. The connecting portion 11 is made of electrically insulate material such as ceramics. The holder 10 is preferably a standard holder such that the LED illumination device 100 can replace a traditional incandescent bulb.

The LED module 20 comprises a circuit board 210 and a plurality of LEDs 211 mounted on the circuit board 210. The circuit board 210 is round. A connecting hole 208 is defined in a center of the circuit board 210. Two securing holes 209 are defined in the circuit board 210 and positioned at two sides of the connecting hole 208. The connecting hole 28 is configured for wires (shown in FIG. 5) extending therethrough to electrically connect the power module 40 and the LED module 20. The power module 40 is assembled in the heat dissipation module 30 and the holder 10 to provide control signals and required power for the LED module 21. The securing holes 209 are used to engagingly receive the screws 12 which connect the LED module 21 and the heat dissipation module 20 together.

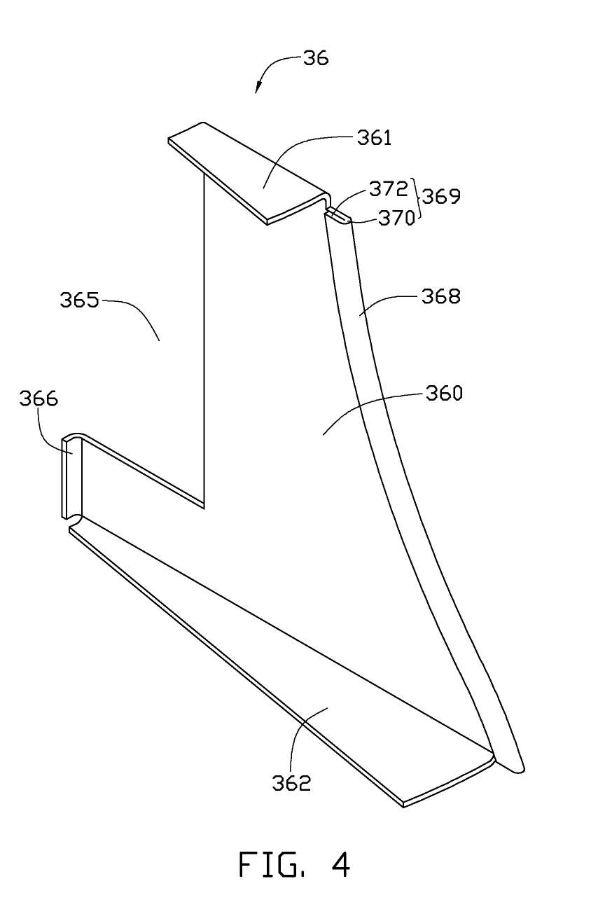

The heat dissipation module 30 is made of material with good heat conductivity such as aluminum, copper or an alloy thereof. The heat dissipation module 30 comprises a tube 31 and a plurality of fins 36 surrounding the tube 31. The fins 36 are attached to an outer surface of the tube 31 and extend radially and outwards from an outer surface of the tube 31. Referring to FIG. 4, each fin 36 comprises a main body 360, a bottom bending plate 362 bending from a bottom edge of the main body 360, a lateral bending plate 366 bending from an inner edge of the main body 360, and a top bending plate 361 bending from a top edge of the main body 360. The main body 360 defines a cutout 365 at a top of the inner edge thereof, for fixing the fin 36 on the tube 31. The bottom, lateral and top bending plates 362, 366, 361 extend along a same direction from the main body 360. A passage is defined between two adjacent main bodies 360 for allowing air to flow therethrough.

An outer edge of the main body 360 is curved and is folded inwards to form a slick flange 369. The slick flange 369 includes a bending portion 370 and a rim 372. The bending portion 370 is formed at the outer edge of the main body 360 and has a smooth outer surface. The rim 372 extends from a lateral side of the bending portion 370. In the present embodiment, the rim 372 is parallel to and overlap the main body 360 at the outer edge of the main body 360.

In assembly, the bottom bending plate 362 is attached to the circuit board 210 of the LED module 20. The top bending plate 361 and the tube 31 are attached to the connecting bowl 111 of the connecting portion 11. The lateral bending plate 366 is attached to the outer surface of the tube 31. The power module 40 inserts in the tube 31 and electrically connects with the LED module 20 and the holder 10.

The envelope 50 is made of transparent or translucent material such as glass or resin. The envelope 50 includes an abutting portion 52 and a semi-spherical light transmitting portion 54 extending from a lateral edge of the abutting portion 52. The abutting portion 52 is engagingly with a lateral side of the circuit board 210.

Each of the fins 36 has a slick flange 369 inwardly folded; therefore, it can keep a small thickness of each fin, enhance a strength of the fins 36, improve a heat dissipating efficiency of the heat sink, and avoid scraping a user.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A heat dissipation module comprising:
a plurality of fins, each fin comprising a main body, a bottom bending plate bending from a bottom edge of the main body, a top bending plate bending from a top edge of the main body, and a flange folding inwards from an outer edge of the main body, the flange overlapping the main body at the outer edge of a corresponding fin.

2. The heat dissipation module of claim 1, wherein the flange comprises a bending portion formed at the outer edge of the main body and a rim extending from a lateral side of the bending portion, the bending portion having a smooth outer surface.

3. The heat dissipation module of claim 1, wherein each fin further comprises a lateral bending plate bending from an inner edge of the main body.

4. The heat dissipation module of claim 1, further comprising a tube surrounded by the fins.

5. The heat dissipation module of claim 4, wherein the fins extend radially and outwards from the outer surface of the tube, a passage being defined between two adjacent main bodies.

6. The heat dissipation module of claim 4, wherein the main body defines a cutout at the inner edge near a top portion thereof for fixing the fin on the tube.

7. A light emitting diode (LED) illumination device comprising:
a heat dissipation module, comprising a plurality of radial fins cooperatively forming an annular structure, each fin comprising a main body, a channel being defined between the main bodies of neighboring fins, a plate extending from an end of each fin to close the corresponding channel at the end of the fin, a flange folding inwards from an outer edge of the main body; and
an LED module comprising an LED light source mounted on an end of the heat dissipation module and contacting the plates of the fins.

8. The LED illumination device of claim 7, wherein the slick flange comprises a bending portion formed at the outer edge of the main body and a rim extending from a lateral side of the bending portion, the bending portion having a smooth outer surface.

9. The LED illumination device of claim 7, wherein each fin comprises a bottom bending plate bending from a bottom edge of the main body, a lateral bending plate bending from an inner edge of the main body, and a top bending plate bending from a top edge of the main body.

10. The LED illumination device of claim 7, wherein the heat dissipation module further comprises a tube surrounded by the fins.

11. The LED illumination device of claim 10, wherein the fins extend outwardly from the outer surface of the tube, a passage being defined between two adjacent main bodies.

12. The LED illumination device of claim 10, wherein the main body defines a cutout at the inner edge near a top portion thereof for fixing the fin on the tube.

13. The LED illumination device of claim 10, further comprising a power module inserting in the tube and electrically connecting the LED light source with the holder.

14. A heat dissipation module comprising a plurality of fins stacked together, each fin comprising a top side, a bottom side opposite to the top side, an inner side between inner ends of the top and bottom sides, and an outer edge opposite to the inner edge and between outer ends of the top and bottom sides, a plate extending from at least one of the top and bottom edges of each fin to abut an adjacent fin, a flange folding from the outer edge of the fin towards the inner edge.

15. The heat dissipation module of claim 14, wherein the flange overlaps the outer side of the fin.

16. The heat dissipation module of claim 14, wherein a channel is defined between two adjacent fins, the channel being open at the inner and outer sides of the fins.
